(19) United States
(12) Patent Application Publication
(10) Pub. No.: US 2010/0007567 A1
(43) Pub. Date: Jan. 14, 2010

(54) ANTENNA FOR AN RFID TRANSPONDER AND RFID TRANSPONDER

(75) Inventor: Achim Hilgers, Alsdorf (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/442,915

(22) PCT Filed: Aug. 21, 2007
(86) PCT No.: PCT/IB07/53335

§ 371 Date: Mar. 25, 2009

(30) Foreign Application Priority Data
Sep. 26, 2006 (EP) 06121295.7
Aug. 21, 2007 (IB) PCT/IB2007/053335

(51) Int. Cl. H01Q 11/12; H01Q 5/00; G06K 19/07

(52) U.S. Cl. 343/741; 235/492

(57) ABSTRACT

An antenna (1, 41) for an RFID transponder (20), comprises a first antenna arm (2, 42), a second antenna arm (3, 43), and a dc-loop structure (14) electrically connected to the first antenna arm (2, 42) at a first connection (15) and to the second antenna arm (3, 43) at a second connection (16). The first antenna arm (2, 42) comprises a first open end (7) and a first terminal end (8) to be connected to an electronic circuit (21) of an RFID transponder (20) and the second antenna arm (3, 43) comprises a second open end (12) and a second terminal end (13) to be connected to the electronic circuit (21). The first antenna arm (2, 42) and the dc-loop structure (14) are coupled to form a first resonance structure with a first resonance frequency, the second antenna arm (3, 43) and the dc-loop structure (14) are coupled to form a second resonance structure with a second resonance frequency, and the first and second antenna arms (2, 3, 42, 43) and the dc loop structure (14) are formed so that the first resonance frequency differs from the second resonance frequency.

### FIELD OF THE INVENTION

The invention relates to an antenna for an RFID transponder and to an RFID transponder.

### BACKGROUND OF THE INVENTION

Usually, a Radio Frequency Identification (RFID) transponder, which is also referred to as a tag or a label, comprises an electronic circuit, normally in the form of an integrated circuit, and an antenna. The electronic circuit is designed to process a signal captured by the antenna and, in response to the captured signal, to generate a response signal to be transmitted by the antenna. The antenna is normally supported by a substrate and the integrated circuit may be attached on a sub-mount, usually called “strap”, by the so-called flip-chip mounting process.

The electronic circuit of the transponder can communicate with a reader/writer system, which is often only referred to as a reader or a base station. The electronic circuit, which may comprise a microprocessor, can be programmed and rewritten by the base station.

For a satisfactory performance, the antenna may be adapted to the operating frequency band of the base station transponder system. In order to adapt the antenna to the actual operating frequency, i.e. to the operating frequency of the area in which the transponder is supposed to be used, the antenna properties are chosen appropriately. Depending on the geographical area in which the transponder is operated, the operating frequency band may differ. In Europe, for instance, the operating frequency band is usually between 865.6 MHz and 867.6 MHz, in the U.S.A., the operating frequency band is usually between 902 MHz and 928 MHz, in Japan, the operating frequency band is usually between 950 MHz and 956 MHz, in Korea, the operating frequency band is usually between 910 MHz and 914 MHz, and in Australia, the operating frequency band is usually between 923 MHz and 928 MHz.

Published U.S.-application for patent No. 2005/0179604 A1 discloses an antenna suitable for use in an RFID tag and designed to be operated in the U.S.A. and in Europe. The antenna comprises a plurality of discrete loop antennas disposed concentrically on a substrate. Each of the loop antenna is electrically isolated from each other.

### OBJECT AND SUMMARY OF THE INVENTION

It is an object of the present invention to provide a further antenna for an RFID transponder which can be used in areas with different operating frequencies.

Another object of the present invention is to provide an RFID transponder being comprised of an antenna and an electronic circuit connected to the antenna, wherein the antenna is designed so that the transponder is operable in different areas of different operating frequencies.

The first object of the invention is achieved by means of an antenna for an RFID transponder, comprising:
a first antenna arm which comprises a first open end and a first terminal end to be connected to an electronic circuit of an RFID transponder;
a second antenna arm which comprises a second open end and a second terminal end to be connected to the electronic circuit; and
a dc-loop structure electrically connected to the first antenna arm at a first connection and to the second antenna arm at a second connection. The first antenna arm and the dc-loop structure are coupled to form a first resonance structure with a first resonance frequency, the second antenna arm and the dc-loop structure are coupled to form a second resonance structure with a second resonance frequency, and the first and second antenna arms and the dc-loop structure are formed so that the first resonance frequency differs from the second resonance frequency.

The second object of the invention is achieved by means of an RFID transponder, comprising the inventive antenna and an electronic circuit having a first terminal connected to the first terminal end, a second terminal connected to the second terminal end, and a first impedance.

The inventive antenna is designed for an RFID transponder and the inventive RFID transponder comprises the inventive antenna and the electronic circuit which is, for instance, an integrated circuit. The inventive antenna has two terminal ends, namely the first and second terminal ends which are meant to be connected to the two terminals of the electric circuit in order to form the inventive RFID transponder.

The inventive antenna itself may particularly be comprised of a relative highly electric conductive material, such as copper, aluminum, silver, or gold, and may, for instance, be attached onto a substrate by, for instance, glueing, milling, etching, or applying laser technologies. The substrate may, for example, be a plastic foil or a printed circuit board, or may be made from paper, ceramics, ferrite materials or a composite of these materials.

An RFID transponder operates with a certain operation frequency. In order to achieve satisfactory performance, the antenna should be tuned to this frequency. Due to the design of the inventive antenna, the inventive antenna has at least two resonance frequencies which result from the two resonance structures. As a result, the same antenna can be used for an RFID transponder for different areas having different operating frequencies without modifying the antenna, particularly if the two resonance frequencies correspond to the different operating frequencies.

The two resonance frequencies may be relatively close together. In one embodiment of the inventive antenna, the first resonance frequency is in the range of 865 to 868 MHz, preferably at 865 MHz, and the second resonance frequency is in the range of 902 to 928 MHz, preferably at 915 MHz. Then, the first resonance frequency corresponds to the operating frequency in Europe and the second resonance frequency corresponds to the operating frequency in the U.S.A. Consequently, this variant of the inventive antenna and this variant of the inventive RFID transponder can be used in Europe and in North America without modifications.

The first resonance frequency may be shifted slightly towards a frequency less than the European center frequency (865 MHz) and the second resonance frequency may be shifted slightly towards a frequency greater than the U.S. center frequency (915 MHz). Then, the inventive antenna and the inventive transponder can also be used in Japan without any modifications.

In one embodiment of the inventive antenna, the first antenna arm comprises a first antenna section running from the first connection to the first open end, the second antenna arm comprises a second antenna section running from the second connection to the second open end, and the dc-loop structure comprises a loop section, wherein the loop section is coupled to the first antenna section to form the first resonance structure and the loop section is coupled to the second antenna section to form the second resonance structure.

In order to obtain the two different resonance frequencies, the coupling between the first antenna section and the dc-loop structure and the coupling between the second antenna section and the dc-loop structure must differ. This may be achieved, in accordance with one embodiment of the inventive antenna, if at least a part of the first arm section runs parallel to the loop section, at least a part of the second arm section runs parallel to the loop section, and the distance between the part of the first arm section running parallel to the loop section differs from the distance between the part of the second arm section running parallel to the loop section. The parts of the first and second antenna section, although preferred, do not necessarily have to have the form of straight line sections; they also can be curved or have, in general, arbitrary forms.

In order to obtain the different couplings between the two antenna sections and the dc-loop structure, alternatively or additionally the length of the part of the first arm section running parallel to the loop section may differ from the length of the part of the second arm section running parallel to the loop section and/or the width of the part of the first arm section running parallel to the loop section may differ from the width of the part of the second arm section running parallel to the loop section.

In order to obtain the different couplings between the dc-loop structure and the first and second antenna arms, the inventive antenna may also be designed so that the dc-loop structure is geometrically unsymmetrical in respect to the first and second antenna arms. Then, the two antenna arms can be designed as being symmetrical to each other, simplifying the design of the inventive antenna.

In general, the two antenna arms or the two antenna sections may have arbitrary forms. In one embodiment of the inventive antenna, however, the two antenna arms or the two antenna sections may be meander like shaped or may be interleaved. This makes a relative compact design of the inventive antenna possible.

Usually, the electronic circuit, which is a part of the inventive RFID transponder or with which the inventive antenna is meant to be combined to form a transponder, has an impedance present at its two terminals.

When operating, the antenna of the inventive RFID transponder is meant to capture signals from a base station and/or to send signals to the base station. The signals captured by the antenna are meant to be processed by the electronic circuit and the signals sent by the antenna are generated by the electronic circuit. In order to obtain a relatively high efficiency of the inventive RFID transponder, the radiation efficiency of the inventive antenna should match relatively well the electronic circuit of the inventive RFID transponder.

Additionally, radio frequency reflection between the inventive antenna and the electronic circuit of the inventive RFID transponder may be reduced, preferably as much as possible. The latter can be achieved by ensuring performance matching between the inventive antenna and the electronic circuit. The theoretical maximum power transfer from the inventive antenna to the electronic circuit is achieved if the impedance of the electronic circuit Z_{c} is complex conjugate to the antenna impedance of the inventive antenna Zₐ i.e. if the following equation is fulfilled:

Z_{c}=Z*ₐ

wherein “*” denotes “conjugate complex and

Z_{c}=R_{c}+jX_{c}

Zₐ=Rₐ+jXₐ

wherein j²=−1, R_{c} is the resistance of the electric circuit or the real part of Z_{c}, X_{c} is the reactance of the electronic circuit or the imaginary part of Z_{c}, Rₐ is the antenna resistance or the real part of Zₐ, and Xₐ is the antenna reactance or the imaginary part of Zₐ.

Thus, the theoretical maximum power transfer from the inventive antenna to the electronic circuit is achieved, if the antenna resistance equals the resistance of the electronic circuit and X_{c}=−Xₐ, implying that the absolute value of the antenna reactance equals the absolute value of the reactance of the electronic circuit. Therefore, the absolute values of the imaginary parts of the antenna impedance and the impedance of the electronic circuit may particularly be at least approximately the same and having opposite signs, and additionally the antenna resistance and the resistance of the electronic circuit may be approximately the same. Particularly, according to one embodiment of the inventive antenna, the impedance of the first resonance structure and the impedance of the second resonance structure match at least approximately the impedance of the electronic circuit. This means that for this variant of the inventive antenna, the resistance of the inventive antenna at the two resonance frequencies is at least approximately equal to the resistance of the electronic circuit and the reactance of the inventive antenna at the two resonance frequencies have at least approximately the same absolute values as the reactance of the electronic circuit, but opposite signs.

In one embodiment of the inventive RFID transponder, the electronic circuit has capacitive behavior, i.e. its reactance is negative. Then, the inventive antenna may especially have an inductive tendency, i.e. having a positive antenna reactance, whose absolute value may preferably be approximately the same as the absolute value of the reactance of the electronic circuit. If additionally the antenna resistance equals approximately the resistance of the electronic circuit, then maximum power transfer between the inventive antenna and the electronic circuit is achievable.

Among other things, the antenna impedance may depend on coupling mechanisms especially in the very near field of the antenna itself, resulting in a changing antenna impedance within the close vicinity of the antenna, caused, for instance, by placing an object relatively close to the transponder. This may also change the resonance condition, resulting in an inferior performance of the transponder. The inventive antenna, however, may have the advantage that its sensitivity to changing boundary conditions may be reduced as well as the operation is made possible in at least two frequency band, which may especially be relatively close together.

### BRIEF DESCRIPTION OF THE DRAWINGS

The invention will be described in greater detail hereinafter, by way of non-limiting examples, with reference to the embodiments shown in the drawings.

FIG. 1 shows an antenna according to the invention;

FIG. 2 shows an RFID transponder;

FIG. 3 shows a diagram showing the properties of the antenna of FIG. 1;

FIG. 4 shows a further antenna according to the invention; and

FIG. 5 shows a diagram showing the properties of the antenna of FIG. 4.

### DESCRIPTION OF EMBODIMENTS

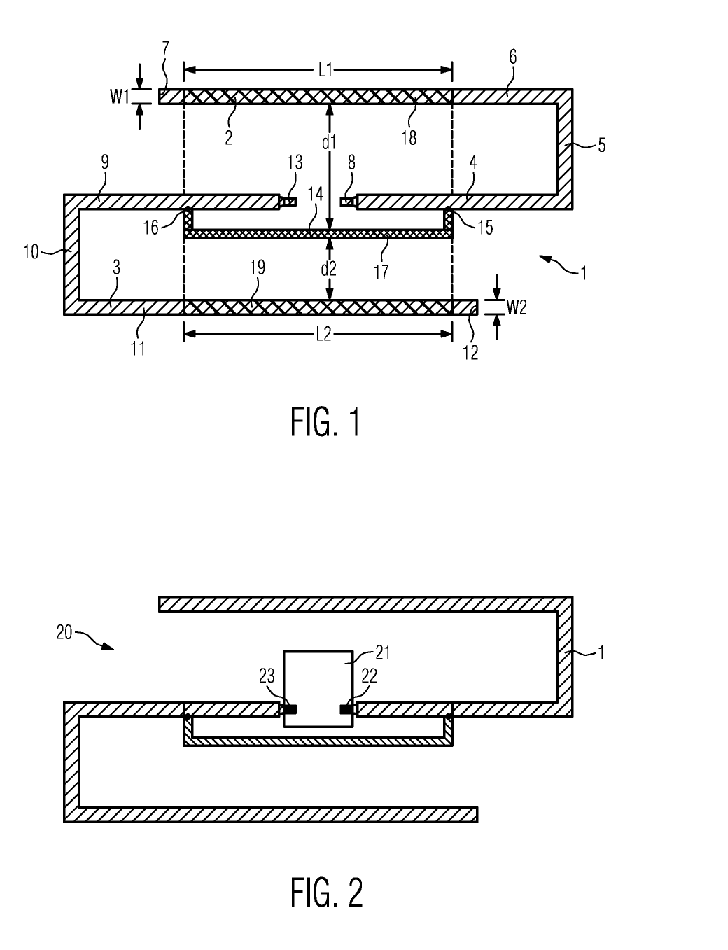

FIG. 1 shows a first example of an antenna 1 suitable to be combined with an electronic circuit to form an RFID transponder 20 which is depicted in FIG. 2. For the exemplary embodiment, the electronic circuit of the transponder 20 is an integrated circuit 21 comprising a first terminal 22 and a second terminal 23. The integrated circuit 21 is designed to process signals captured by the antenna 1 and/or to generate signals to be sent by the antenna 1 in a well known manner.

The antenna 1 is made from copper for the exemplary embodiment and is attached to a substrate not shown in the figures. The antenna 1 comprises a first antenna arm 2 and a second antenna arm 3. For the exemplary embodiment, the first antenna arm 2 is meander like shaped, has three substantially straight line sections 4, 5, 6 with a width of w1, an open end 7, and is terminated by a first terminal end 8. The first terminal end 8 is meant to be connected to the first terminal 22 of the integrated circuit 21 to form the transponder 20. For the exemplary embodiment, the first terminal end 8 is directly connected to the first terminal 22 of the integrated circuit 21.

For the exemplary embodiment, the second antenna arm 3 is also meander like shaped, has three straight line sections 9, 10, 11 with a width of w2, an open end 12, and is terminated by a second terminal end 13. The second terminal end 13 is meant to be connected to the second terminal 23 of the integrated circuit 21 to form the transponder 20. For the exemplary embodiment, the second terminal end 13 is directly connected to the second terminal 23 of the integrated circuit 21. Additionally, the width w1 and the width w2 of the two antenna arms 2, 3, respectively, are substantially the same for the exemplary embodiment. This is, however, not necessarily required and the two widths w1, w2 can also differ.

The antenna 1 further comprises a dc-loop 14 which has two ends which are connected to the first and second antenna arms 2, 3. Particularly, one of the ends of the dc loop 14 is connected to the first antenna arm 2 at a connection 15 and the other end of the dc loop 14 is connected to the second antenna arm 3 at a connection 16.

The dc-loop 14 comprises a loop section 17, which has the form of a straight line for the exemplary embodiment and which runs substantially parallel to a part of the line section 6 of the first antenna arm 2 at a distance dl and to a part of the line section 11 of the second antenna arm 2 at a distance d2. The mentioned part of the line section 6 is denoted by reference sign 18 and the mentioned part of the line section 11 is denoted by reference sign 19.

Due to this particular construction, the first antenna arm 2 and particularly the part 18 of the line section 6 of the first antenna arm 2 is coupled to the dc-loop 14 and particularly to the loop section 17, so that the dc-loop 14 and the first antenna arm 2 form a first resonator with a first resonance frequency f₁. The first resonance frequency f₁ depends on a degree of coupling between the first antenna arm 2 and the dc loop 14. The degree of coupling depends on the length L1 and the width w1 of the part 18 of the line section 6 of the first antenna arm 2 and the distance d1 between the part 18 of the line section 6 of the first antenna arm 2 and the loop section 17.

Due to this particular construction, the second antenna arm 3 and particularly the part 19 of the line section 11 of the second antenna arm 3 is coupled to the dc loop 14 and particularly to the loop section 17, so that the dc-loop 14 and the second antenna arm 3 form a second resonator with a second resonance frequency f₂. The second resonance frequency f₂ depends on the degree of coupling between the second antenna arm 3 and the dc-loop 14. The degree of coupling depends on the length L2 and the width w2 of the part 19 of the line section 19 of the second antenna arm 3 and the distance d2 between the part 19 of the line section 11 of the second antenna arm 3 and the loop section 17.

For the exemplary embodiment, the lengths L1 and L2 are substantially the same, the width w1 and w2 are substantially the same, but the distances d1 and d2 differ. As a result, the first resonance frequency f₁ and the second resonance frequency f₂ differ.

When forming the transponder 20, then the antenna 1 cooperates with the integrated circuit 21. The integrated circuit 21, as discussed above, has an impedance

Z_{c}=R_{c}+jX_{c}

For the exemplary embodiment, the impedance Z_{c} has capacitive behavior, i.e.

the reactance, X_{c}, is negative. Furthermore, the antenna 1 has an impedance

Zₐ=Rₐ+jXₐ

In order to obtain a relative high power transfer from the antenna 1 to the integrated circuit 21, the following condition should be satisfied:

Rₐ=R_{c}

Xₐ=−X_{c}

Thus, for the exemplary embodiment, the antenna 1 and particularly the width w1, w2 and the overall lengths l₁ and l₂ of the first antenna arm 2 and the second antenna arm 3 are chosen to satisfy at least approximately this condition for at least the two resonance frequencies f₁, f₂.

For the exemplary embodiment, the transponder 20 is meant to be operated in Europe and in the U.S.A. Therefore, the widths w1, w2, the lengths L1, L2, and the distances d1, d2 are chosen for the exemplary embodiment, so that the first resonance frequencies f₁ equals 865 MHz and the second resonance frequencies f₂ equals 915 MHz.

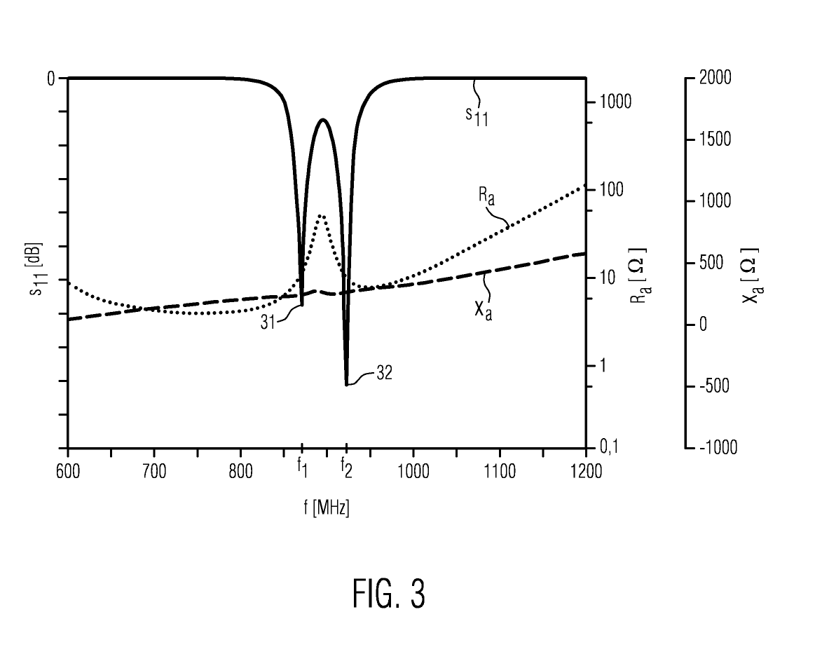

FIG. 3 shows the scattering parameter s₁₁ between the antenna 1 and the integrated circuit 21 of the transponder 20 as a solid line, the antenna resistance Rₐ as a dotted line, and the antenna reactance Xₐ as a dashed line as a function of the frequency f. The scattering parameter s₁₁ is normalized in respect to the impedance Z_{c} of the integrated circuit 21.

As is evident from FIG. 3, the antenna 1 has two resonance peaks 31, 32 at the two resonance frequencies f₁, f₂. Since the first resonance frequency f₁, corresponds to the operating frequency in Europe and the second resonance frequency f₂ corresponds to the operating frequency in North America, the antenna 1 can be used for transponders and the transponder 20 can be used in Europe and in North America without modifications. If the antenna 1 is slightly modified so that the first resonance frequency f₁ is slightly shifted to frequencies slightly less than 865 MHz and the second resonance frequency f₂ is slightly shifted to frequencies slightly greater than 915 MHz, then the antenna 1 and the transponder 20 can also be used in Japan. Another solution to extend the area of operation of the antenna 1 or the transponder 20 is to add a third antenna arm which forms a third resonator with a third resonance frequency f₃ being different from the first and second resonance frequencies f₁,f₂. Then, the third antenna arm should be dimensioned so that the third resonance frequency f₃ is in the range of a further operation area. Additionally, the third arm should be dimensioned so that the antenna impedance Zₐ matches the impedance Z_{c} of the integrated circuit 21 around the three resonance frequencies f₁, f₂, f₃.

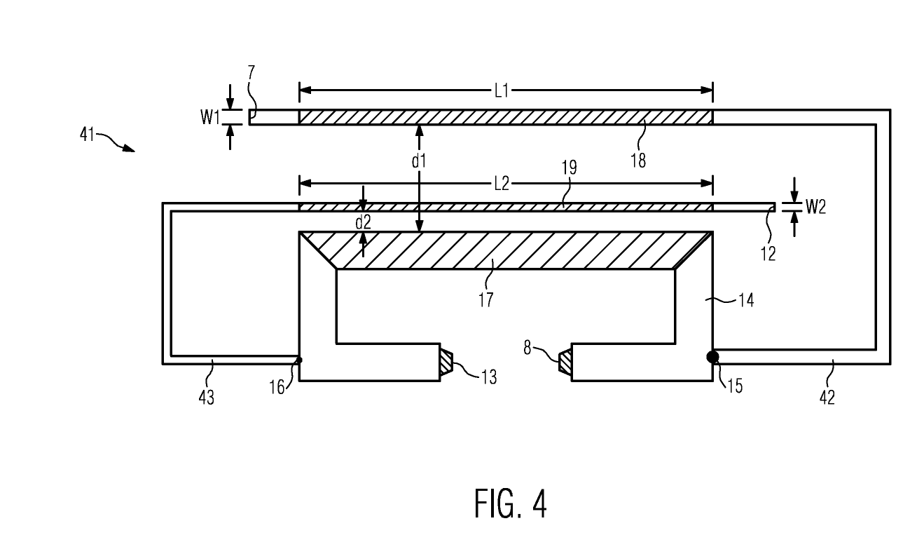

FIG. 4 shows a further antenna 41 which can be used for the transponder 20 instead of the antenna 1. If not explicitly mentioned, then components of the antenna 41 of FIG. 4 which are similar to components of the antenna 1 of FIG. 1 are denoted with the same reference signs.

In comparison to the two antenna arms 2, 3 of the antenna 1 of FIG. 1, the antenna arms 42, 43 of the antenna 41 are interleaved and the width w2 of the second antenna arm 43 is less than the width w1 of the first antenna arm 42 for the exemplary embodiment.

As the antenna 1 of FIG. 1, the dc-loop 14 comprises a loop section 17 which runs substantially parallel with a part 18 of a line section of the first antenna arm 42 and substantially parallel with a part 19 of a line section of the second antenna arm 42. Thus, the part 18 of the first antenna arm 42 is coupled to the loop section 17 forming a first resonator having the first resonance frequency f₁ and the part 19 of the second antenna arm 43 is coupled to the loop section 17 forming a second resonator having the second resonance frequency f₂. The two resonance frequencies f₁, f₂, depend on the widths w1, w2 of the two antenna arms 42, 43, the distances d1, d2 between the parts 18, 19 of the first and second antenna arms 42, 43, respectively, and the loop section 17, and the lengths L1, L2.

For the exemplary embodiment, the distance d1 between the part 18 of the first antenna arm 42 and the loop section 17 is greater than the distance d2 between the part 19 of the second antenna arm 43 and the loop section 17. The two lengths L1, L2 are substantially the same.

For the exemplary embodiment, the transponder 1 is meant to be operated in Europe and in the U.S.A. Therefore, the widths w1, w2, the lengths L1, L2, and the distances d1, d2 are chosen for the exemplary embodiment, so that the first resonance frequencies f₁ equals 865 MHz and the second resonance frequencies f₂ equals 915 MHz. Furthermore, the antenna 41 and particularly the width w1, w2 and the overall lengths L1 and L₂ of the first antenna arm 42 and second antenna arm 43 are chosen so that the antenna impedance, Zₐ, matches at least approximately the impedance Z_{c} of the integrated circuit 21 for at least the two resonance frequencies f₁, f₂.

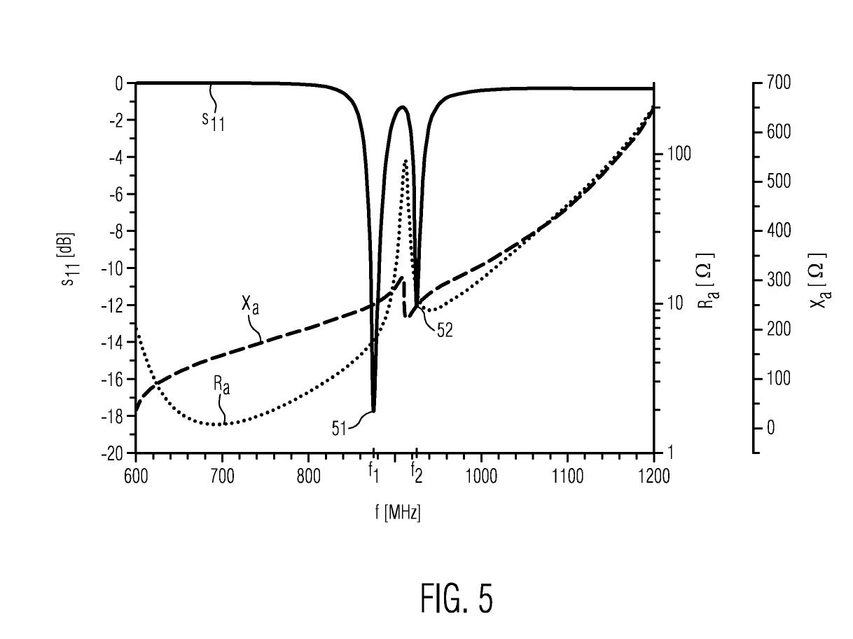

FIG. 5 shows the scattering parameter s₁₁ between the antenna 41 and the integrated circuit 21 of the transponder 20 as a solid line, the antenna resistance Rₐ as a dotted line, and the antenna reactance Xₐ as a dashed line as a function of the frequency f. The scattering parameter s₁₁ is normalized in respect to the impedance Z_{c} of the integrated circuit 21.

As is evident from FIG. 5, the antenna 41 has two resonance peaks 51, 52 at the two resonance frequencies f₁, f₂. Since the first resonance frequency f₁ corresponds to the operating frequency in Europe and the second resonance frequency f₂, corresponds to the operating frequency in North America, the antenna 41 can be used for transponders 20 and the transponders 20 can advantageously be used in Europe and in North America without modifications. If the antenna 41 is slightly modified so that the first resonance frequency f₁ is slightly shifted to frequencies slightly less than 865 MHz and the second resonance frequency f₂ is slightly shifted to frequencies slightly greater than 915 MHz, then the antenna 1 and the transponder 20 can also be used in Japan. Another solution to extend the area of operation of the antenna 41 or the transponder 20 is to add a third antenna arm which forms a third resonator with a third resonance frequency f₃ different from the first and second resonance frequencies f₁, f₂. Then the third antenna arm should be dimensioned so that the third resonance frequency f₃ is in the range of a further operation area. Additionally, the third arm should be dimensioned, so that the antenna impedance Zₐ matches the impedance Z_{c} of the integrated circuit 21 around the three resonance frequencies f₁,f₂,f₃.

For the exemplary embodiments discussed above, the distances d1 and d2 differ and for the second exemplary embodiment the widths w1 and w2 differ. A different coupling between the two antenna arms 2, 3, 42, 43 and the dc-loop 14 can also be achieved by different lengths L1, L2.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. An antenna for an RFID transponder, comprising:
a first antenna arm which comprises a first open end and a first terminal end to be connected to an electronic circuit of an RFID transponder;
a second antenna arm which comprises a second open end and a second terminal end to be connected to the electronic circuit; and
a dc-loop structure electrically connected to the first antenna arm at a first connection and to the second antenna arm at a second connection; the first antenna arm and the dc-loop structure being coupled to form a first resonance structure with a first resonance frequency, the second antenna arm and the dc-loop structure being coupled to form a second resonance structure with a second resonance frequency, and the first and second antenna arms and the dc-loop structure being formed so that the first resonance frequency differs from the second resonance frequency.

2. The antenna of claim 1, wherein the dc loop structure is designed so that it is geometrically unsymmetrical in respect to the first and second antenna arms.

3. The antenna of claim 1, wherein the first antenna arm includes a first antenna section running from the first connection to the first open end, the second antenna arm includes a second antenna section running from the second connection to the second open end, and the dc-loop structure includes a loop section which is coupled to the first antenna section to form the first resonance structure and is further coupled to the second antenna section to form the second resonance structure.

4. The antenna of claim 3, wherein at least part of the first antenna arm section runs substantially parallel to the loop section, at least part of the second antenna arm runs substantially parallel to the loop section, and a first distance between the part of the first antenna arm section running substantially parallel to the loop section differs from a second distance between the part of the second antenna arm running substantially parallel to the loop section.

5. The antenna of claim 3, wherein at least part of the first antenna arm runs substantially parallel to the loop section, at least part of the second antenna arm section runs substantially parallel to the loop section, and a first length of the part of the first antenna arm running substantially parallel to the loop section differs from a second length of the part of the second antenna arm running substantially parallel to the loop section.

6. The antenna of claim 3, wherein at least part the first antenna arm runs substantially parallel to the loop section, at least part of the second antenna arm runs substantially parallel to the loop section, and a first width of the part of the first antenna arm running substantially parallel to the loop section differs from a second width of the part of the second antenna arm running substantially parallel to the loop section.

7. The antenna of claim 3, wherein the first antenna arm and second antenna arm have a meander or interleaved like structure.

8. The antenna of claim 1, wherein an impedance of the first resonance structure and an impedance of the second resonance structure substantially match an impedance of the electronic circuit.

9. The antenna of claim 1, wherein the first resonance frequency is in the range of 865 to 868 MHz and the second resonance frequency is in the range of 902 to 928 MHz.

10. An RFID transponder, comprising:
an antenna; and
an electronic circuit including a first terminal connected to a first terminal end, a second terminal connected to a second terminal end, and the electronic circuit having a first impedance.

11. The transponder of claim 10, wherein the antenna has a second impedance and absolute values of imaginary parts of the first and second impedances are substantially the same but of opposite signs.

12. The transponder of claim 11, wherein the real part of the first impedance is negative.
